(19) United States
(12) Patent Application Publication
(10) Pub. No.: US 2026/0071864 A1
(43) Pub. Date: Mar. 12, 2026

(54) APPARATUS AND METHOD FOR OPTICAL TOMOGRAPHY WITH EXTENDED IMAGING DEPTH

(71) Applicant: ELECTRONICS AND TELECOMMUNICATIONS RESEARCH INSTITUTE, Daejeon (KR)

(72) Inventors: Hyun-Woo SONG, Daejeon (KR); Jin-Tae KIM, Daejeon (KR); Jeong-Won PARK, Daejeon (KR)

(21) Appl. No.: 19/325,299

(22) Filed: Sep. 10, 2025

(30) Foreign Application Priority Data
Sep. 10, 2024 (KR) 10-2024-0123231

(51) Int. Cl. G01B 9/02091; G01B 11/24

(52) U.S. Cl. CPC G01B 9/02091; G01B 11/2441

(57) ABSTRACT

Disclosed herein is an apparatus and method for optical tomography with extended imaging depth. The apparatus obtains a three-dimensional (3D) optical tomography image of a sample based on interference between reference beam and sample beam that is scattered from or through the sample after being irradiated by a light source, and may include a sample region optical unit for adjusting the depth of a focal plane in the sample while maintaining an optical path length constant by translating the sample by a predetermined length along the optical axis of light incidence for the sample.

### CROSS REFERENCE TO RELATED APPLICATION

This application claims the benefit of Korean Patent Application No. 10-2024-0123231, filed Sep. 10, 2024, which is hereby incorporated by reference in its entirety into this application.

### BACKGROUND OF THE INVENTION

### 1. Technical Field

The disclosed embodiment relates to technology for extending imaging depth in label-free 3D optical tomography.

### 2. Description of the Related Art

In conventional optical coherence tomography applied to biological imaging, the limitation of imaging depth is regarded as being primarily due to scattering or absorption by a sample.

In spectral domain optical coherence tomography, the limitation of imaging depth is thought to be attributable to spectral resolution, and in wavelength swept source optical coherence tomography, the limitation of imaging depth is thought to be attributable to the linewidth of a wavelength swept source. That is, when a sample is very transparent and the amount of scattering is low, a deep imaging range may be obtained when the linewidth of a light source is narrow, and this is because the narrower the linewidth of the light source, the longer the instantaneous coherence length.

For the above-described reasons, when optical coherence tomography is used to acquire a biological image, it is common to obtain an imaging range of a few millimeters due to scattering by biological tissues. However, although an eye is a very transparent biological structure, it is impossible to observe the retina when imaging the cornea and vice versa in optical coherence tomography due to the imaging depth allowed in current commercialized technology.

Meanwhile, optical coherence tomography that uses a surface-emitting laser with a micro resonator as a wavelength swept source has been reported. The linewidth of this source is very narrow, and the instantaneous coherence length covers several hundreds of meters. In related art document 1 (Z. Wang, et al., “Cubic meter volume optical coherence tomography,” Optica, 3, (12), 1496-1503 (2016)), an image with the depth of a few centimeters to a hundred centimeters was actually demonstrated by utilizing such a light source and by acquiring data using a high-speed oscilloscope. However, in order to acquire an optical tomography image with such a large imaging depth, high-speed data acquisition technology is also required.

In other words, in order to acquire an image with a large imaging depth in optical coherence tomography, expensive devices, such as a wavelength-swept vertical-cavity surface-emitting laser and high-speed data acquisition device, are required.

Furthermore, optical coherence tomography that uses a light source with a very long instantaneous coherence length additionally requires very stable interferometers and phase compensation techniques, and in related art document 1 described above, a photonic integrated circuit is introduced to actually realize a tomography image with the depth of 100 centimeters.

Meanwhile, because optical holographic tomography uses laser as a light source, if a sample is sufficiently transparent, the high coherence may overcome the limitation of imaging depth. However, when a light source with high coherence is used, optical holographic tomography systems become vulnerable due to requirements to control speckle noise and vibrations. Accordingly, commercial products of optical diffraction tomography that improves imaging stability by applying a partially coherent source to an optical holographic tomography system, as in related art document 2 (Korean Patent No. 10-2355140, “Method and apparatus for three-dimensional optical tomography using partially coherent light and multiple illumination patterns”, written by YongKeun Park and Herve Jerome Hugonett and registered on Jan. 20, 2022), are being released. However, optical diffraction tomography using such a partially coherent source has the limitation of imaging depth and has the problem of image quality degradation for thick biological samples.

### SUMMARY OF THE INVENTION

An object of the disclosed embodiment is to overcome the limitation of imaging depth in optical tomography.

Another object of the disclosed embodiment is to provide sufficient imaging depth without the use of expensive techniques for compensating for the disadvantages of label-free 3D optical tomography.

An apparatus for optical tomography with extended imaging depth according to an embodiment obtains a three-dimensional (3D) optical tomography image of a sample based on interference between reference beam and sample beam that is scattered from or through the sample after being irradiated, and the apparatus may include a sample region optical unit for adjusting the depth of a focal plane in the sample while maintaining an optical path length constant by translating the sample by a predetermined length along the optical axis of light incidence for the sample.

Here, the sample region optical unit may include a housing filled with cleared media, a stage on which the sample is placed in the cleared media within the housing, and a translation control unit for translating the stage along the optical axis of light incidence for the sample.

Here, the cleared media may minimize the difference in refractive index between the cleared media and the sample around the center wavelength.

Here, the 3D optical tomography image may be a label-free 3D optical tomography image.

Here, the apparatus for optical tomography with extended imaging depth according to an embodiment may further include a light source, a light detector, a coupler for splitting light from the light source into sample beam and reference beam, a reference arm part by which the reference beam from the coupler is reflected by a reflector and is then directed into the coupler, and a sample arm part by which the sample beam from the coupler is directed for the sample to be measured and sample beam scattered from or through the sample is directed into the coupler, and the sample arm part may include the sample region optical unit.

Here, the light source may generate partially coherent light.

Here, the sample arm part may further include a scanner for directing the sample beam toward the sample and a focusing lens for focusing the sample beam from the scanner for the sample.

Here, the reference arm part may compensate for an optical path length in the sample arm part.

Here, compensation may be performed for the optical path length in the reference beam through hardware or software.

Here, the apparatus may further include a control unit for obtaining a 3D optical tomography image of the sample based on an interference signal between the sample beam scattered from or through the sample and the reference beam by the detector by controlling the sample arm part, and the control unit may combine 3D optical tomography images of the sample corresponding to focal planes of different depths, which are obtained by translating the sample by the predetermined length multiple times by controlling the sample region optical unit.

Here, the apparatus for optical tomography with extended imaging depth according to another embodiment may reconstruct a 3D image from multiple two-dimensional (2D) images acquired using a device that repeats phase shift with respect to a reference by scanning at three or more incident angles, using three or more patterns, using a spatial light modulator (SLM), or using a spatial light inference microscope with a partially coherent light for the sample.

Here, the device that repeats the phase shift may include focusing lenses for imaging light scattered from the focal plane of the sample onto an image plane and a phase modulator at a conjugate plane to repeatedly phase-shift the light imaged by the focusing lenses.

Here, the apparatus may further include a control unit for obtaining a 3D optical tomography image of the sample based on phase-shifted 2D images by controlling the phase modulator and the sample region optical unit, and the control unit may reconstruct a 3D image of the sample based on 2D images of the sample corresponding focal planes of different depths, which are acquired by translating the sample by the predetermined length multiple times by controlling the sample region optical unit.

Here, the control unit may collect 2D images by repeating phase shift by controlling the phase modulator each time the control unit translates the sample by the predetermined length by controlling the sample region optical unit.

In a method for optical tomography with extended imaging depth according to an embodiment, a 3D optical tomography image of a sample is obtained based on interference between reference beam and sample beam that is reflected from or through the sample after being irradiated by a light source, and the method may include adjusting the depth of a focal plane in the sample while maintaining an optical path length constant by translating the sample by a predetermined length along the optical axis of light incidence for the sample.

The method for optical tomography with extended imaging depth according to an embodiment may further include obtaining a 3D optical tomography image of the sample corresponding to the focal plane of the depth adjusted by translating the sample, and may further include, after repeating adjusting the depth of the focal plane and obtaining the 3D optical tomography image of the sample by translating the sample by the predetermined length multiple times, combining 3D optical tomography images of the sample corresponding to focal planes of different depths.

Here, obtaining the 3D optical tomography image may include splitting the light from the light source into sample beam and reference beam, accepting reference beam reflected from a reflector by directing the reference beam onto the reflector, accepting sample beam scattered from or through the sample by directing the sample beam for the sample to be measured, making interference between the sample beam and the reference beam, and reconstructing the 3D optical tomography image of the sample based on interference between the reference beam and the sample beam scattered from or through the sample.

The method for optical tomography with extended imaging depth according to another embodiment may further include acquiring at two-dimensional (2D) image for repeated phase shift of the light scattered from or through the sample corresponding to the focal plane of the depth adjusted by translating the sample by the predetermined length multiple times, and may further include, after repeating adjusting the depth of the focal plane and acquiring the 2D image, reconstructing a 3D image of the sample based on 2D images for repeated phase shift of the light scattered from or through the sample corresponding to focal planes of different depths.

A sample region optical device according to an embodiment may include a housing filled with cleared media, a stage on which a sample is placed in the cleared media within the housing, and a translation control unit for translating the stage along the optical axis of light incidence.

Here, the cleared media may minimize the difference in refractive index between the cleared media and the sample around the center wavelength.

### BRIEF DESCRIPTION OF THE DRAWINGS

The above and other objects, features, and advantages of the present disclosure will be more clearly understood from the following detailed description taken in conjunction with the accompanying drawings, in which:

FIGS. 1 and 2 are exemplary views of a sample region optical unit included in an apparatus for acquiring an optical tomography image with extended imaging depth according to an embodiment;

FIG. 3 is a schematic configuration diagram of a light-sheet fluorescence imaging device;

FIG. 4 is a schematic configuration diagram of an optical coherence tomography apparatus including a sample region optical unit according to an embodiment;

FIG. 5 is a schematic configuration diagram of an optical diffraction tomography apparatus including a sample region optical unit according to an embodiment;

FIG. 6 is an exemplary view of the spatial light interference microscope of FIG. 5;

FIG. 7 is a flowchart for explaining a method for acquiring an optical tomography image with extended imaging depth in an optical coherence tomography apparatus according to an embodiment;

FIG. 8 is a flowchart for explaining a method for acquiring an optical tomography image with extended imaging depth in an optical diffraction tomography apparatus according to an embodiment; and

FIG. 9 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

As described above, a living biological sample is cultured for an extended period in the state in which it is immersed in a medium, and the volume and growth rate thereof may be monitored through 3D imaging. However, as the biological sample grows and increases in volume, the quality of a 3D image of the entire volume is deteriorated, which indicates that the imaging depth reaches the limit.

An optical tomography apparatus using a partially coherent light source has the limitation of imaging depth.

In order to overcome the limitation, an apparatus and method for acquiring an optical tomography image that configures a sample region optical unit in consideration of a coherence length according to an embodiment so as to extend imaging depth in optical tomography for biological samples are disclosed.

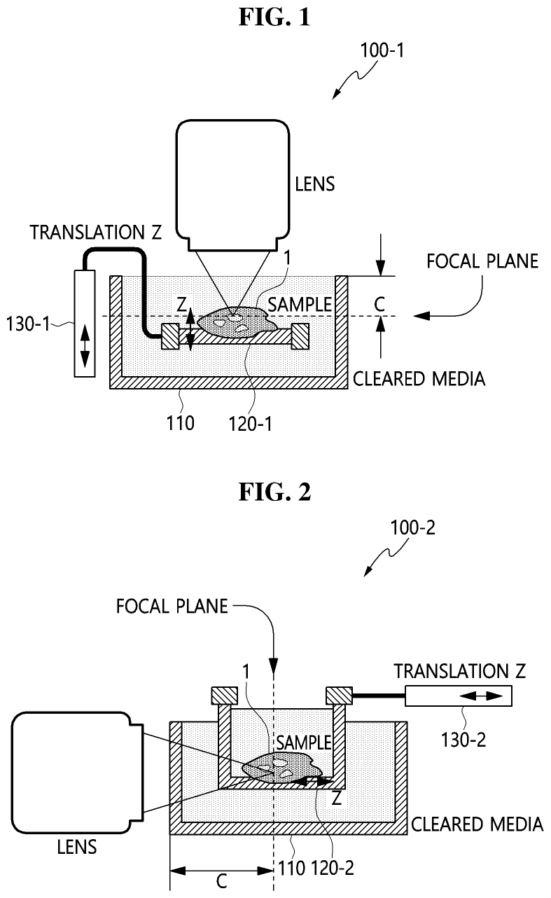

FIGS. 1 and 2 are exemplary views of a sample region optical unit included in an apparatus for acquiring an optical tomography image with extended imaging depth according to an embodiment.

Referring to FIGS. 1 and 2, the apparatus for optical tomography with extended imaging depth according to an embodiment obtains a three-dimensional (3D) optical tomography image of a sample based on interference between reference beam and sample beam that is scattered from or through the sample after being irradiated by a light source, and may include a sample region optical unit 100-1 or 100-2 that adjusts the depth of a focal plane in the sample while maintaining an optical path length constant by translating the sample by a predetermined length along the optical axis of light incidence for the sample.

Here, the sample region optical unit 100-1 or 100-2 may include a housing 110 filled with cleared media, a stage 120-1 or 120-2 on which a sample 1 is placed in the cleared media within the housing 110, and a translation control unit 130-1 or 130-2 for translating the stage 120-1 or 120-2 along the optical axis of light incidence for the sample.

For example, in the sample region optical unit 100-1 illustrated in FIG. 1, light is incident on the sample 1 from above, and the stage 120-1 may be controlled to move up and down by the translation control unit 130-1.

On the other hand, in the sample region optical unit 100-2 illustrated in FIG. 2, light is incident on the sample 1 from the left, and the stage 120-2 may be controlled to move from side to side by the translation control unit 130-2.

However, the sample region optical units 100-1 and 100-2 illustrated in FIGS. 1 and 2 are merely examples of the present disclosure, and the present disclosure is not limited thereto. That is, the sample region optical unit according to an embodiment may have various embodiments for the form thereof.

Meanwhile, the sample region optical unit 100-1 or 100-2 according to an embodiment may be configured such that the stage 120-1 or 120-2 on which the sample 1 is placed is immersed in culture media and such that the optical path length C does not change even though the sample 1 is translated.

To this end, the sample region optical unit 100 according to an embodiment allows the media in which the sample 1 is immersed to be cleared around the central wavelength of an optical tomography light source.

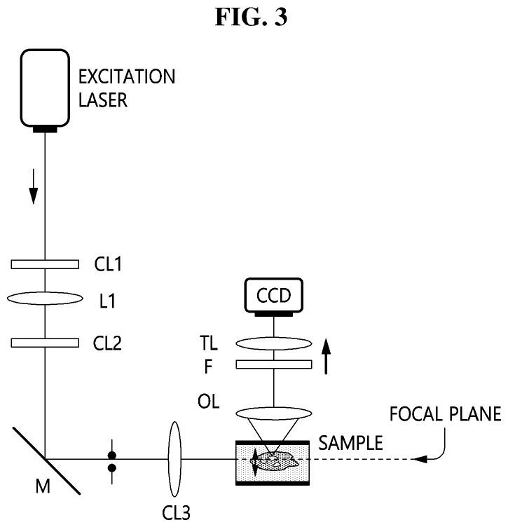

Generally, when imaging a biological sample, matching the refractive indices of the medium and the sample (index matching) is primarily used as shown in FIG. 3 in light-sheet fluorescence microscopy.

FIG. 3 is a schematic configuration diagram of a light-sheet fluorescence imaging device.

The light-sheet fluorescence imaging device illustrated in FIG. 3 is disclosed in related art document 3 (P. Liao, et al., “Three-dimensional digital PCR through light-sheet imaging of optically cleared emulsion,” PNAS, 117, (41), 25628-25633 (2020).), and it uses cleared media as the culture solution in which a biological sample is immersed, so that an excitation laser is kept planar when exciting fluorophores in the sample.

However, the technology illustrated in FIG. 3 is 3D imaging technology for imaging a biological sample by labeling the biological sample with fluorophores, it is not label-free 3D optical tomography that we are looking into.

In contrast, the sample region optical unit 100-1 or 100-2 according to the embodiments illustrated in FIGS. 1 and 2 is applied to an optical tomography apparatus using a partially coherent light source, thereby overcoming the limitation of imaging depth and providing label-free 3D optical tomography with extended imaging depth.

To this end, the cleared media used in the sample region optical units 100-1 and 100-2 illustrated in FIGS. 1 and 2 may minimize the difference in refractive index between the cleared media and the sample.

Accordingly, even though the sample 1 is translated by a certain distance in the z direction, not only the geometric length but also the optical path length C may remain constant. As a result, in the optical tomography apparatus, imaging is possible through compensation in consideration of the optical path length C, and additional imaging depth may be obtained by translating the sample in the z direction.

That is, according to an embodiment, compensation may be performed for the optical path length in the reference beam through hardware or software.

Meanwhile, the optical tomography apparatus with extended imaging depth according to an embodiment further includes a control unit(not illustrated) for reconstructing a 3D optical tomography image of the sample based on interference between scattered beam and reference beam, and the control unit may combine 3D optical tomography images of the sample corresponding to focal planes of different depths, which are acquired by translating the sample by the predetermined length multiple times by controlling the sample region optical unit 100-1 or 100-2.

The optical tomography apparatus with extended imaging depth according to an embodiment, which includes the above-described sample region optical unit 100-1 or 100-2 according to an embodiment, may be applied to various techniques for acquiring optical tomography images.

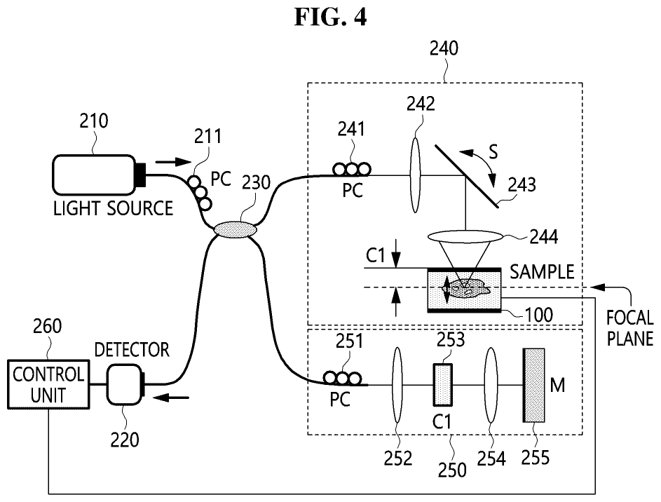

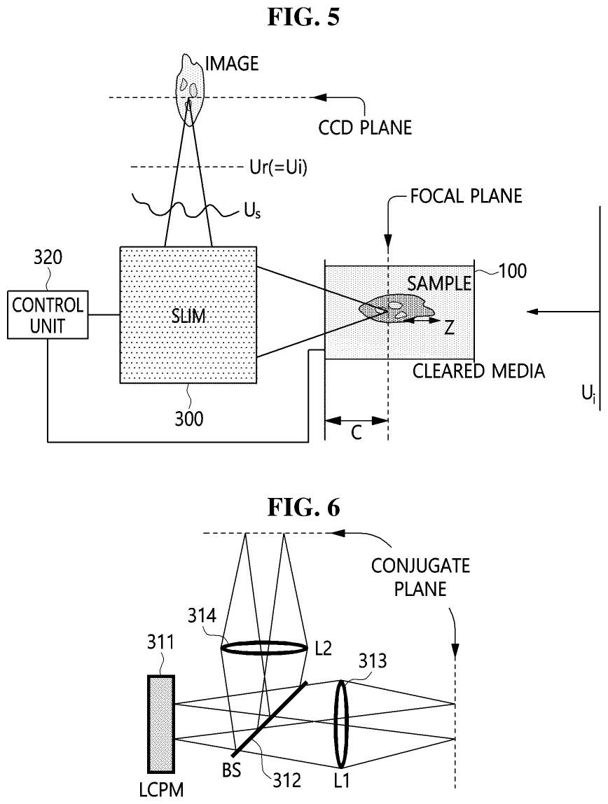

FIG. 4 illustrates an example in which the sample region optical unit 100-1 or 100-2 according to an embodiment is applied to technology for acquiring an optical coherence tomography image, and FIGS. 5 and 6 illustrate examples in which the sample region optical unit 100-1 or 100-2 according to an embodiment is applied to technology for acquiring an optical diffraction tomography image. However, these are merely embodiments of the present disclosure, and the present disclosure is not limited thereto.

FIG. 4 is a schematic configuration diagram of an apparatus for acquiring an optical coherence tomography image in which a sample region optical unit according to an embodiment is included.

Referring to FIG. 4, the apparatus for optical tomography with extended imaging depth according to an embodiment may include a light source 210, a light detector 220, a coupler 230 for splitting light from the light source 210 into sample beam and reference beam, a sample arm part 240 by which the sample beam from the coupler 230 is incident onto a sample to be measured and then the sample beam scattered from or through the sample is directed into the coupler 230, and a reference arm part 250 by which the reference beam from the coupler 230 is reflected from a reflector 255 and is then directed into the coupler 230.

Here, the light source 210 may be a wavelength swept laser.

Here, the sample arm part 240 may adjust the depth of a focal plane in the sample while maintaining the optical path length constant by translating the sample by a predetermined length along the optical axis of the sample beam.

That is, as label-free 3D imaging technology, the optical coherence tomography apparatus includes the sample region optical unit 100 in the sample arm part 240 configured with a Michelson interferometer.

Here, the sample arm part 240 may include a scanner 243 for directing the sample beam toward the sample, a focusing lens 244 for focusing the sample beam from the scanner 243 onto the sample, and the sample region optical unit 100 for translating the sample along the optical axis of the sample beam.

Here, the sample region optical unit 100 may include a housing 110 filled with cleared media, a stage 120 on which a sample is placed in the cleared media within the housing 110, and a translation control unit 130 for translating the stage 120 along the optical axis of the sample beam, as illustrated in FIGS. 1 and 2.

Here, the cleared media may minimize the difference in refractive index between the cleared media and the sample around the center wavelength.

That is, the partially coherent light experiences the optical path length C from the surface of the sample region optical unit 100 to the focal plane through the imaging lens 244 and returns through scattering in the sample region optical unit 100.

According to an embodiment, the reference arm part 250 is configured to compensate for the optical path length C1 (253) of the sample region optical unit 100.

Accordingly, using the cleared media in which the sample is immersed in the sample region optical unit 100, the reference arm part 250 is compensated for the same optical path length C1, and A scan image signal may be acquired.

Here, according to an embodiment, the compensation may be performed in a software manner.

Meanwhile, the apparatus for optical tomography with extended imaging depth according to an embodiment may further include a control unit 260 for obtaining a 3D optical tomography image of the sample based on interference between the sample beam and the reference beam acquired by the detector 220 by controlling the sample arm part 240.

Here, the control unit 260 may reconstruct an image by combining the 3D optical tomography images of the sample corresponding to focal planes of different depths, which are obtained by translating the sample by the predetermined length multiple times by controlling the sample region optical unit 100.

That is, even though the sample is translated by a certain distance in the z direction after performing imaging for the given imaging depth, the difference in the optical path length between the sample arm 240 and the reference arm 250 remains constant, and imaging for given imaging depth may be repeatedly performed again.

Accordingly, the final imaging depth obtained by the control unit 260 may be expanded to two, three, or more times the given imaging depth by connecting the image obtained at the given imaging depth and the image obtained after translating the sample in the z direction by a predetermined length.

Accordingly, even though the biological sample immersed in the cleared media grows and increases in volume, label-free 3D optical tomography imaging of the entire volume is possible without deterioration of the image quality.

In addition, the apparatus for optical tomography with extended imaging depth according to an embodiment may selectively further include polarization controllers (PCs) 211, 241, and 251 and lenses 242, 244, 252, and 254.

Although FIG. 4 is described in consideration of swept source optical coherence tomography of the optical coherence tomography apparatus including the sample region optical unit according to an embodiment, it may also be applied to a time domain optical coherence tomography apparatus, a spectral domain optical coherence tomography apparatus, and the like.

FIG. 5 is a schematic configuration diagram of an optical diffraction tomography apparatus including a sample region optical unit according to an embodiment, and FIG. 6 is an exemplary view of the spatial light interference microscope of FIG. 5.

Referring to FIG. 5, the sample region optical unit 100 is applied to optical diffraction tomography using a partially coherent light source, whereby optical diffraction tomography with extended imaging depth is obtained.

The optical diffraction tomography apparatus including the sample region optical unit according to an embodiment uses a Spatial Light Interference Microscope (SLIM) 300.

That is, a 3D optical tomography image of a sample is reconstructed based on the scattered waves (Uₛ) of the sample through the Spatial Light Interference Microscope (SLIM) 300, that is, 2D images acquired through phase shifts (e.g., 0, π/2, π, and 3π/2) of the scattered waves (Uₛ).

The sample region optical unit 100 enables an optical path length C to remain constant even though the sample is translated in the z direction and scanned, so the same coherence is maintained over the entire range of the sample, and the imaging depth does not cause image quality degradation in the optical diffraction tomography apparatus.

Therefore, when a biological sample immersed in a medium is cultured for an extended period, even though the biological sample grows and increases in volume beyond a certain size, a 3D image of the entire volume may be obtained without deterioration of the image quality. The optical diffraction tomography with extended imaging depth may be useful to monitor the volume and growth rate of a relatively large organoid (or a cell aggregate) through 3D imaging during culturing.

The optical diffraction tomography apparatus according to an embodiment includes the sample region optical unit 100 and acquires multiple 2D images using a device that repeats phase shift (e.g., 0, π/2, π, and 3π/2) with respect to reference light by scanning at three or more incident angles, using three or more patterns, or using a spatial light modulator (SLM) in the way of illumination with a partially coherent light on the sample.

While scanning in the imaging depth direction (z), a label-free 3D image of the specimen is reconstructed from the 2D phase image acquired at each focal plane. Here, the focal plane and the image plane (CCD plane) are conjugate planes to each other.

In an embodiment, referring to FIG. 6, the Spatial Light Interference Microscope (SLIM) 300 may include a Liquid Crystal Phase Modulator (LCPM) 311, a Beam Splitter (BS) 312, a first focusing lens L1 313, and a second focusing lens L2 314.

The scattered light from the focal plane of the sample is imaged onto the image plane (CCD plane) through the first focusing lens L1 313 and the second focusing lens L2 314. The focal plane and the image plane (CCD plane) are conjugate planes to each other, and the surface of the Liquid Crystal Phase Modulator (LCPM) also becomes a conjugate plane.

Then, the image data onto the image plane is phase-modulated by the liquid crystal phase modulator 311 located between the first focusing lens L1 313 and the second focusing lens L2 314. For example, phase modulation is repeated at 0, π/2, π, 3π/2, and the like.

The optical diffraction tomography apparatus according to an embodiment may further include a control unit 320 for obtaining a 3D optical tomography image of the sample based on 2D images that are phase-modulated with respect to reference light and scattered from or through the sample by controlling the spatial light interference microscope 300 and the sample region optical unit 100.

The control unit 320 may reconstruct a 3D image of the sample based on the 2D images of the sample corresponding to focal planes of different depths, which are acquired by translating the sample by a predetermined length multiple times by controlling the sample region optical unit 100.

Specifically, the control unit 320 may collect 2D images by repeating phase shift by controlling the spatial light interference microscope 300 each time it translates the sample by a predetermined length by controlling the sample region optical unit 100.

That is, z-scanning is performed by collecting 2D images for each phase shift by performing phase shifts of 0, π/2, π, 3π/2, etc. for the same sample location z and by then collecting 2D images by performing phase shifts of 0, π/2, π, 3π/2, etc. again for a new sample location z+Δz after the sample region optical unit 100 translates the sample by Δz in the z-direction.

Through the 2D phase images acquired in this way, a 3D image of the sample is reconstructed (reference: Kim, et al., “White-light diffraction tomography of unlabeled live cells,” Nature Photonics, 8, 256-263, 2014.).

Such phase information is acquired by interference between incident light (reference light) and scattered light, that is, diffraction, and when the sample region optical unit is introduced, the sample region optical unit enables the optical path length to remain constant even though a sample is translated in the z direction in the cleared media, so the coherence that affects the image quality is maintained even though the thickness of the sample increases.

Although the description of FIGS. 5 and 6 is made in consideration of the optical diffraction tomography apparatus using the spatial light interference microscope (SLIM) of the optical diffraction tomography image acquisition apparatus including the sample region optical unit according to an embodiment, it may also be applied to an optical diffraction tomography image acquisition apparatus that performs phase modulation with respect to reference light by scanning at three or more incident angles, using three or more patterns, or using a spatial light modulator in order to acquire phase-shifted images. Here, phase modulation according to an embodiment is performed at the conjugate plane.

Also, the phase modulator according to an embodiment may perform phase modulation by scanning at three or more incident angles, using three or more patterns, or using a spatial light modulator in the way of illumination with a partially coherence light for the sample.

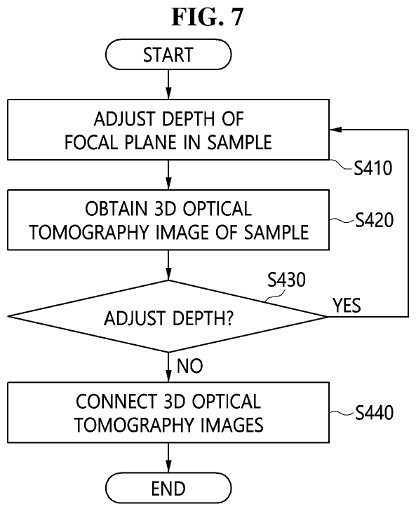

FIG. 7 is a flowchart for explaining a method for obtaining an optical tomography image with extended imaging depth in an optical coherence tomography apparatus according to an embodiment.

Referring to FIG. 7, in the method for optical tomography with extended imaging depth according to an embodiment, a 3D optical tomography image of a sample is obtained based on interference between reference beam and sample beam that is reflected from the sample after being irradiated by a light source, and the method may include adjusting the depth of a focal plane in the sample while maintaining an optical path length constant by translating the sample by a predetermined length along the optical axis of light incidence for the sample at step S410.

Here, the method for optical tomography with extended imaging depth according to an embodiment may further include obtaining a 3D optical tomography image of the sample corresponding to the focal plane of the depth adjusted by translating the sample by the predetermined length multiple times at step S420, and may further include combining 3D optical tomography images of the sample corresponding to focal planes of different depths at step S440 after repeating the step (S410) of adjusting the depth of the focal plane and the step (S420) of obtaining the 3D optical tomography image of the sample at step S430.

Here, the sample is immersed in cleared media, and the cleared media may minimize the difference in refractive index between the cleared media and the sample.

Here, the 3D optical tomography image may be a label-free 3D optical tomography image.

Here, compensation may be performed for the optical path length in the reference beam through hardware or software.

Here, acquiring the 3D optical tomography image of the sample at step S420 according to an embodiment may include splitting light from the light source into sample beam and reference beam, accepting reference beam reflected from a reflector by directing the reference beam onto the reflector, accepting sample beam reflected from the sample to be measured, and making interference between the reference beam and the sample beam scattered from or through the sample, and reconstructing the 3D optical tomography image of the sample based on the interference data.

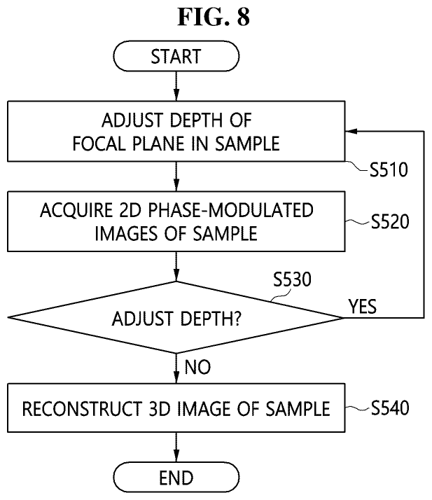

FIG. 8 is a flowchart for explaining a method for obtaining an optical tomography image with extended imaging depth in an optical diffraction tomography apparatus according to an embodiment.

Referring to FIG. 8, in the method for optical tomography with extended imaging depth according to an embodiment, a 3D optical tomography image of a sample is acquired based on interference between reference wave and scattered wave that is scattered through the sample after being irradiated by a light source, and the method may include adjusting the depth of a focal plane in the sample while maintaining an optical path length constant by translating the sample by a predetermined length along the optical axis of light incidence for the sample at step S510.

Here, the method for optical tomography with extended imaging depth according to an embodiment may further include acquiring a 2D image through repeated phase shift of light scattered from the sample corresponding to the focal plane of the depth adjusted by translating the sample by the predetermined length multiple times at step S520, and may further include, after repeating the step (S510) of adjusting the depth of the focal plane and the step (S520) of acquiring the 2D image at step S530, reconstructing a 3D image at step S540 based on 2D images acquired through the repeated phase shift of the light scattered through the sample corresponding to the focal planes of different depths.

Here, the sample is immersed in cleared media, and the cleared media may minimize the difference in refractive index between the cleared media and the sample.

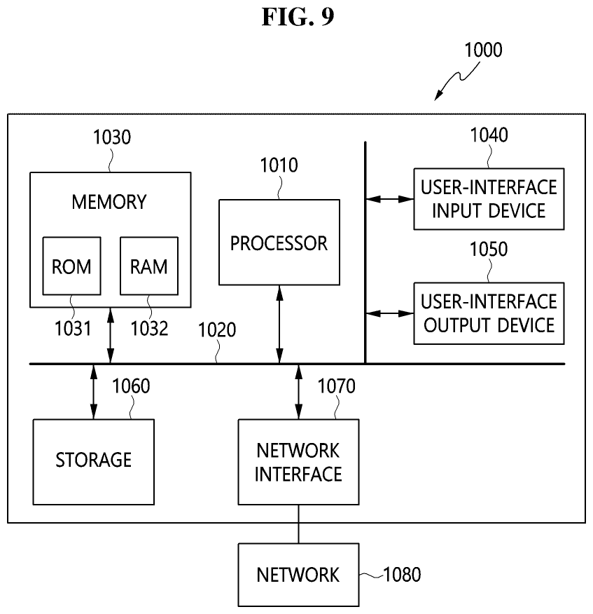

FIG. 9 is a view illustrating a computer system configuration according to an embodiment.

The control unit of the apparatus for acquiring an optical tomography image with extended imaging depth according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, a sample region optical unit is applied to optical coherence tomography, whereby the limitation of imaging depth may be overcome and the imaging depth may be extended.

According to the disclosed embodiment, when the volume and growth rate of a living biological sample immersed in a medium are monitored through 3D imaging during long-term culturing, the above-described technique enables a high-quality 3D image of the entire volume to be acquired even as the biological sample grows and increases in volume.

The utilization of high-depth, label-free 3D imaging technology is increasing, and it is expected to be used for new drug development, regenerative medicine, personalized medicine, etc. by being applied to the biomedical field, especially organoid imaging technology.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. An apparatus for optical tomography with extended imaging depth, configured to obtain a three-dimensional (3D) optical tomography image of a sample based on interference between reference beam and sample beam that is scattered from or through the sample after being irradiated, comprising:
a sample region optical unit for adjusting depth of a focal plane in the sample while maintaining an optical path length constant by translating the sample by a predetermined length along an optical axis of light incidence for the sample.

2. The apparatus of claim 1, wherein the sample region optical unit includes
a housing filled with cleared media;
a stage on which the sample is placed in the cleared media within the housing; and
a translation control unit for translating the stage along the optical axis of light incidence.

3. The apparatus of claim 2, wherein the cleared media minimize a difference in refractive index between the cleared media and the sample around the center wavelength.

4. The apparatus of claim 1, wherein the 3D optical tomography image is a label-free 3D optical tomography image.

5. The apparatus of claim 1, further comprising:
a light source;
a detector;
a coupler for splitting light from the light source into sample beam and reference beam;
a reference arm part by which the reference beam from the coupler is reflected from a reflector and is then directed into the coupler; and
a sample arm part by which the sample beam from the coupler is directed for the sample to be measured and sample beam scattered from or through the sample is directed into the coupler,
wherein the sample arm part includes the sample region optical unit.

6. The apparatus of claim 5, wherein the light source generates partially coherent light.

7. The apparatus of claim 5, wherein the sample arm part further includes
a scanner for directing the sample beam to a sample region; and
a focusing lens for focusing the sample beam from the scanner for the sample.

8. The apparatus of claim 5, wherein the reference arm part compensates for an optical path length in the sample arm part.

9. The apparatus of claim 8, wherein compensation is performed for the optical path length in the reference beam through hardware or software.

10. The apparatus of claim 5, further comprising:
a control unit for obtaining a 3D optical tomography image of the sample based on an interference signal between the sample beam scattered from or through the sample and the reference beam by controlling the sample arm part,
wherein the control unit combines 3D optical tomography images of the sample corresponding to focal planes of different depths, which are obtained by translating the sample by the predetermined length multiple times by controlling the sample region optical unit.

11. The apparatus of claim 1, wherein
a 3D image is reconstructed from multiple two-dimensional (2D) images acquired through a device that repeats phase shift with respect to a reference by scanning at three or more incident angles, using three or more patterns, using spatial light modulator, or using a spatial light interference microscope with a partially coherent light for the sample.

12. The apparatus of claim 11, wherein the device that repeats the phase shift includes
focusing lenses for imaging light scattered from a focal plane of the sample onto an image plane; and
a phase modulator at a conjugate plane to repeatedly phase-shift the light imaged by the focusing lenses.

13. The apparatus of claim 12, further comprising:
a control unit for obtaining the 3D optical tomography image of the sample based on phase-shifted 2D images by controlling the phase modulator and the sample region optical unit,
wherein the control unit reconstructs a 3D image of the sample based on 2D images of the sample corresponding focal planes of different depths, which are acquired by translating the sample by the predetermined length multiple times by controlling the sample region optical unit.

14. The apparatus of claim 13, wherein the control unit collects the 2D images by repeating phase shift by controlling the phase modulator each time, the control unit translates the sample by the predetermined length by controlling the sample region optical unit.

15. A method for optical tomography with extended imaging depth to obtain a three-dimensional (3D) optical tomography image of a sample based on interference between reference beam and sample beam that is scattered from or through the sample after being irradiated by a light source, comprising:
adjusting depth of a focal plane in the sample while maintaining an optical path length constant by translating the sample by a predetermined length along an optical axis of light incidence for the sample.

16. The method of claim 15, further comprising:
obtaining a 3D optical tomography image of the sample corresponding to the focal plane of the depth adjusted by translating the sample; and
after repeating adjusting the depth of the focal plane and obtaining the 3D optical tomography image of the sample by translating the sample by the predetermined length multiple times,
combining 3D optical tomography images of the sample corresponding to focal planes of different depths.

17. The method of claim 16, wherein obtaining the 3D optical tomography image of the sample comprises
splitting light from the light source into sample beam and reference beam;
accepting reference beam reflected from a reflector by directing the reference beam onto the reflector;
accepting sample beam scattered from or through the sample by directing the sample beam for the sample to be measured;
making interference between the sample beam and the reference beam; and
reconstructing the 3D optical tomography image of the sample based on interference between the reference beam and the sample beam scattered from or through the sample.

18. The method of claim 15, further comprising:
acquiring a two-dimensional (2D) image for repeated phase shift of the light scattered from or through the sample corresponding to the focal plane of the depth adjusted by translating the sample by the predetermined length multiple times; and
after repeating adjusting the depth of the focal plane and acquiring the 2D image,
reconstructing a 3D image of the sample based on 2D images for repeated phase shift of the light scattered from the sample corresponding to focal planes of different depths.

19. A sample region optical device, comprising:
a housing filled with cleared media;
a stage on which a sample is placed in the cleared media within the housing; and
a translation control unit for translating the stage along an optical axis of light incidence.

20. The sample region optical device of claim 19, wherein the cleared media minimize a difference in refractive index between the cleared media and the sample around the center wavelength.
